(19) United States
(12) Patent Application Publication
(10) Pub. No.: US 2018/0346675 A1
(43) Pub. Date: Dec. 6, 2018

(54) THERMOSETTING RESIN COMPOSITION, PREPREG CONTAINING SAME, LAMINATED BOARD, AND PRINTED CIRCUIT BOARD

(71) Applicant: Shengyi Technology Co., Ltd., Guandong (CN)

(72) Inventors: Wenxin Chen, Guangdong (CN); Cuiming Du, Guangdong (CN); Songgang Chai, Guangdong (CN)

(21) Appl. No.: 15/780,621

(22) PCT Filed: Sep. 14, 2016
(86) PCT No.: PCT/CN2016/099122

§ 371 Date: May 31, 2018

(30) Foreign Application Priority Data
Dec. 7, 2015 (CN) 201510895451.0

(51) Int. Cl. C08J 9/10; C08J 5/24; C08L 79/08; C08L 71/00; C08L 67/00; C08L 63/00; C08L 83/04; C08K 5/00

(52) U.S. Cl. CPC C08J 9/106; C08J 5/24; C08J 9/107; C08L 79/08; C08L 71/00; C08L 67/00; C08J 2300/24; C08L 83/04; C08K 5/0025; C08L 2312/00; C08L 2203/20; C08L 2205/04; C08L 63/00

(57) ABSTRACT

A thermosetting resin composition. The composition comprises thermosetting resin, a cross-linking agent, accelerator, and a porogen. The porogen is a porogen capable of being dissolved in an organic solvent. The organic solvent is an organic solvent capable of dissolving the thermosetting resin. A mode of directly adding the dissolvable porogen to a resin system is used, tiny pores that are uniform in pore diameter can be evenly distributed in resin matrix by means of a simple process at low cost, and the high-performance composition having a low dielectric constant and low dielectric loss is obtained; the method has good applicability to a great number of resin systems; because the pore size in the system reaches a nanometer grade, performance of the final system, such as mechanical strength, thermal performance and water absorption rate, is not sacrificed.

### TECHNICAL FIELD

The present invention relates to a thermosetting resin composition and uses thereof, specifically to a thermosetting resin composition, a resin glue, a prepreg, a laminate and a printed circuit board obtained therefrom.

### BACKGROUND ART

With the rapid development of electronic products in the direction of miniaturization, multi-functionalization, high performance, and high reliability, printed circuit boards have begun to develop rapidly toward high precision, high density, high performance, micropore-formation, thinning and multilayering. Its application is more and more extensive, rapidly from large-scale electronic computers for industrial use, communication instruments, electrical measurements, defense, aerospace and the like to civilian appliances and related products. With further increase of circuit integration density, the speed and accuracy of signal transmission have put forward higher requirements on the dielectric properties of the substrate material.

In order to reduce the dielectric constant of substrate materials for printed circuits, the following three major methods are currently used.

(1) Introducing a certain amount of air into the system by using hollow inorganic filler in CN102206399A, so as to reduce the dielectric constant. However, such technical route needs to make certain surface chemical modification due to worse interface binding ability between inorganic powder and polymer resin, so as to increases production process and production cost.
(2) Adding a micropore foaming agent in CN103992620A. Although the solution can greatly reduce the dielectric constant of the system through a relatively cheaper technical route, the particle size and distribution of the micropores generated in the resin system are not controllable because the foaming agent used therein is insoluble in common organic solvents and easy to aggregate into groups in the actual preparation process. Moreover, larger micropore size may easily cause a significant decrease in mechanical strength and readily result in cause CAF risk. Thus it cannot satisfy the production and application requirements of printed circuits.
(3) Grafting dicarbonate groups which are easily decomposable onto epoxy resins as described in CN1802407A to achieve fine control of the foamed areas and pore size. However, this technical route has a higher selectivity for the resin system, and the cost of preparing the resin is increased accordingly.

Therefore, it has an important practical significance to develop a high-performance resin composition with advanced technology, simple process, low cost, uniform and tiny voids, a low dielectric constant and a low dielectric loss.

### DISCLOSURE OF THE INVENTION

In view of the deficiencies of the prior art, the first object of the present invention is to provide a thermosetting resin composition having a low dielectric constant and a low dielectric loss.

The thermosetting resin composition of the present invention comprises a thermosetting resin, a crosslinking agent, an accelerator and a porogen, wherein the porogen is soluble in an organic solvent.

The organic solvent can dissolve thermosetting resins.

By adding a porogen which is soluble in an organic solvent to disperse it at a molecular level into a thermosetting resin matrix so as to form a homogenous system with high polymers, the porogen is uniformly dispersed in the resin system in a molecular state. When the thermosetting resin composition cross-links and cures at a temperature above 100° C., the porogen decomposes in situ to produce small molecular gases, such as nitrogen gas, carbon dioxide and the like, so as to make pores be uniformly distributed in the thermosetting resin system. Moreover, the pore size can reach the nanometer level without affecting the thermal and mechanical properties of the materials.

The present invention does not make any limitation to the organic solvent, and the organic solvents capable of dissolving the thermosetting resin all can be used in the present invention.

As compared to common porogens for thermoplastic resins such as azodicarbonamide, the porogen capable of being dissolved in a specific organic solvent according to the present invention can improve the processability of the porogen, facilitate the dispersion at a molecular level in the thermosetting resin matrix, and achieve the pore forming effect of even regional distribution and uniform pore size.

The organic solvent of the present invention is any one selected from the group consisting of N,N-dimethylformamide, N,N-dimethylacetamide, dimethyl sulfoxide, N-methyl-2-pyrrolidone, propylene glycol methyl ether, propylene glycol methyl ether acetate, ethyl acetate, dichloromethane, cyclohexanone, butanone, acetone, ethanol, toluene, xylene, and a mixture of at least two selected therefrom

The typical but non-limitative organic solvents which can dissolve the porogen of the present invention comprise the combination of N,N-dimethylformamide and dimethyl sulfoxide, the combination of N-methyl-2-pyrrolidone and acetone, the combination of propylene glycol methyl ether acetate, ethyl acetate and xylene, the combination of N,N-dimethylformamide, N,N-dimethylacetamide and butanone, the combination of cyclohexanone, butanone, acetone and N-methyl-2-pyrrolidone, the combination of propylene glycol methyl ether, propylene glycol methyl ether acetate and cyclohexanone, the combination of N-methyl-2-pyrrolidone, propylene glycol methyl ether, propylene glycol methyl ether acetate, ethyl acetate and dimethyl sulfoxide, the combination of ethyl acetate, dichloromethane, cyclohexanone, butanone and N,N-dimethylformamide and so on.

Preferably, the porogen is any one selected from the group consisting of azo compound, nitroso compound, dicarbonate compound, azide compound, hydrazine compound, triazole compound, urea-amino compound, and a combination of at least two selected therefrom.

The typical but non-limitative example of the azo compound of the present invention is any one selected from the group consisting of azobenzene, p-hydroxyazobenzene, 4-methylamino azobenzene, and a combination of at least two selected therefrom. The typical but non-limitative examples of the combination above comprise the combination of p-hydroxyazobenzene and 4-methylamino azobenzene, the combination of azobenzene, p-hydroxyazobenzene and 4-methylamino azobenzene and so on.

The typical but non-limitative example of the nitroso compound of the present invention is any one selected from the group consisting of methylbenzyl nitrosamine, diethylnitrosamine, pyrrolidine nitrosamine, dibutyl nitrosamine, diamyl nitrosamine, ethyl-dihydroxyethyl nitrosamine, N,N-dinitrosopentamethylene tetraamine, and a combination of at least two selected therefrom. The typical but non-limitative examples of the combination above comprise the combination of N,N-dinitrosopentamethylene tetraamine and diethylnitrosamine, the combination of pyrrolidine nitrosamine and diamyl nitrosamine, the combination of methylbenzyl nitrosamine, diethylnitrosamine and pyrrolidine nitrosamine, the combination of methylbenzyl nitrosamine, diethylnitrosamine and N,N-dinitrosopentamethylene tetraamine and so on.

The typical but non-limitative example of the dicarbonate compound of the present invention is any one selected from the group consisting of octyl dicarbonate, dicyclohexyl dicarbonate, methyl ethyl dicarbonate, and a combination of at least two selected therefrom. The typical but non-limitative examples of the combination above comprise the combination of dicyclohexyl dicarbonate and methyl ethyl decarbonate, the combination of octyl dicarbonate, dicyclohexyl dicarbonate and methyl ethyl decarbonate and so on.

The typical but non-limitative example of the azide compound of the present invention is selected from the group consisting of aryl azide compounds, alkyl azide compounds, acyl azide compounds, sulfonyl azide compounds and phosphoryl azide compounds.

The typical but non-limitative example of the hydrazine compound of the present invention is sulfonyl hydrazine compound, such as any one selected from the group consisting of benzene sulfonyl hydrazide (BSH), p-toluene sulfonyl hydrazide (TSH), 2,4-toluene disulfonyl hydrazide, p-(N-methoxyformamido)benzene sulfonyl hydrazide, and a combination of at least two selected therefrom. The typical but non-limitative examples of the combination above comprise the combination of benzene sulfonyl hydrazide and 2,4-toluene disulfonyl hydrazide, the combination of p-(N-methoxy-formamido)benzene sulfonyl hydrazide and 2,4-toluene disulfonyl hydrazide, the combination of benzene sulfonyl hydrazide, p-toluene sulfonyl hydrazide (TSH) and p-(N-methoxyformamido)benzene sulfonyl hydrazide and so on.

Preferably, the porogen of the present invention can decompose and release gas at 100-190° C.

The use of the porogen which can decompose and release gas at a temperature of 100-190° C. can effectively control the period of pore formation, stabilize the pore size, and obtain pores with more uniform pore size and more even distribution.

The typical but non-limitative example of the temperature at which the porogen of the present invention can decompose and release gas is selected from the group consisting of 110° C., 120° C., 130° C., 142° C., 148° C., 155° C., 163° C., 168° C., 175° C., 182° C. and 188° C. and the like.

Preferably, the porogen is nitroso compound and/or azide compound, further preferably azide compound, particularly preferably sulfonyl azide compound, most preferably 4-methylbenzenesulfonyl azide.

Preferably, the porogen is a liquid-like azide compound. The azide compound has a wide decomposition temperature range and can slowly decompose during the entire lamination and heating process of the copper clad laminate, so as to avoid pore collapse caused by the early decomposition, and greater internal stress produced during the later decomposition. In addition, the azide compound has a lower decomposition bond energy and less heat generated during decomposition as compared to azo and nitroso porogens, so as to have less effect on the reaction process of the matrix resin and little effect on the thermal performance.

When the porogen is solid nitroso compound, said nitroso compound is in a powder shape having an average particle size of 0.1-20 μm, preferably 0.5 μm, 2 μm, 4 μm, 5 μm, 7 μm, 10 μm and 15 μm, preferably 0.5-10 μm.

Preferably, the porogen is present in an amount of 10 wt. % or less in the thermosetting resin composition, e.g. 1 wt. %, 3 wt. %, 4 wt. %, 6 wt. %, 7 wt. %, 8 wt. %, 9 wt. % and the like, preferably 2-8 wt. %, further preferably 2-5 wt. %. A high amount of the porogen will affect the mechanical performance of the thermosetting resin, resulting in reducing the mechanical performance thereof.

As a preferred technical solution, the thermosetting resin composition of the present invention comprises the following components, in percent by weight, from 50 to 90 wt. % of a thermosetting resin, less than 30 wt. % of a crosslinking agent, from 0.1 to 10 wt. % of an accelerator and less than 10 wt. % of a porogen, wherein the sum of the weight percents of all components in the composition is 100 wt. %.

Preferably, the thermosetting resin composition comprises the following components, in percent by weight, from 50 to 70 wt. % of a thermosetting resin, from 10 to 30 wt. % of a crosslinking agent, from 3 to 10 wt. % of an accelerator and from 3 to 10 wt. % of a porogen, wherein the sum of the weight percents of all components in the composition is 100 wt. %.

Said expression “comprising/comprise(s)” of the present invention means that, in addition to the components, other components may be included, and impart different properties to the resin composition. In addition, said “comprising/comprise(s)” described in the present invention may also be replaced by “is/are” or “consisting/consist(s) of” in a closed manner. Regardless of the components in the thermosetting resin composition of the present invention, the sum of the weight percents of the components in the thermosetting composition is 100%.

For example, the thermosetting resin composition may also contain various additives and functional fillers. As specific examples, the additives comprise flame retardants, coupling agents, antioxidants, heat stabilizers, antistatic agents, ultraviolet absorbers, pigments, colorants or lubricants and the like. Examples of functional fillers comprise silica powder, boehmite, hydrotalcite, alumina, carbon black, core-shell rubber and the like. These various additives or fillers may be used separately or in combination of two or more.

The thermosetting resin of the present invention is any one selected from the group consisting of polymers crosslinkable to form a network structure, or a combination of at least two selected therefrom, preferably any one selected from the group consisting of epoxy resin, phenolic resin, cyanate resin, polyamide resin, polyimide resin, polyether resin, polyester resin, hydrocarbon resin, silicone resin, and a combination of at least two selected therefrom, further preferably epoxy resin or phenolic resin.

Specific examples of the combination of the thermosetting resins may be a combination of epoxy resin and polyamide resin, a combination of polyimide resin and hydrocarbon resin, a combination of cyanate resin, polyamide resin and polyether resin, and a combination of cyanate resin, polyamide resin, polyimide resin and epoxy resin and so on.

For epoxy resin and combinations thereof with other resins, the curing agent may be one selected from the group consisting of phenolic resin, acid anhydride compound, active ester compound, dicyandiamide, diaminodiphenylmethane, diaminodiphenyl-sulfone, diaminodiphenyl ether, maleimide, and a mixture of two or more selected therefrom. The curing accelerator is one selected from the group consisting of 2-methylimidazole, 2-ethyl-4-methylimidazole, 2-methyl-4-phenylimidazole, and a mixture of two or more selected therefrom. For phenolic resin and combinations thereof with other resins, the curing agent may be selected from the group consisting of organic acid anhydride, organic amine, Lewis acid, organic amide, imidazole compound and organic phosphine compound, as well as a mixture thereof in any ratio.

For olefin resin, reactive polyphenylene ether resin containing two or more unsaturated double bonds, polyamide resin and combinations thereof with other resins, the curing agent is an organic peroxide crosslinking agent, preferably one or more selected from the group consisting of dicumyl peroxide, benzoyl peroxide, di-tert-butyl peroxide, diacetyl peroxide, t-butyl peroxypivalate and diphenoxy peroxydicarbonate. The accelerator is an allyl organic compound, preferably one or more selected from the group consisting of triallyl cyanurate, triallyl isocyanurate, trimethylolpropane trimethacrylate and trimethylolpropane triacrylate.

For silicone resin, the accelerator is selected from organic platinum compounds.

As a method for preparing the thermosetting resin composition of the present invention, it can be prepared by formulating, stirring and mixing the thermosetting resin, cross-linking agent, accelerator, porogen, and various additives and fillers through known methods.

The second object of the present invention is to provide a resin glue obtained by dispersing the thermosetting resin composition stated in the first object in a solvent.

Preferably, the resin glue is obtained by dissolving the thermosetting resin composition in any of claims 1-6 in a solvent.

Preferably, the solvent is any one selected from the group consisting of N,N-dimethylformamide, N,N-dimethylacetamide, dimethyl sulfoxide, N-methyl-2-pyrrolidone, propylene glycol methyl ether, propylene glycol methyl ether acetate, ethyl acetate, dichloromethane, cyclohexanone, butanone, acetone, ethanol, toluene, xylene, and a combination of at least two selected therefrom.

The above solvent may be used separately or in combination. Preferably, aromatic hydrocarbon solvents, such as toluene, xylene, mesitylene and the like are used together with ketone solvents, such as acetone, butanone, methyl ethyl ketone, methyl isobutyl ketone, cyclohexanone and the like. The amount of the solvent can be selected by those skilled in the art according to their own experience, so that the obtained resin glue can reach a viscosity suitable for use.

The third object of the present invention is to provide a prepreg comprising a reinforcing material and the thermosetting resin composition according to the first object above attached thereon after impregnating and drying.

The fourth object of the present invention is to provide a laminate comprising at least one prepreg according to the third object above.

The fifth object of the present invention is to provide a printed circuit board, comprising at least one laminate according to the fourth object above.

As compared to the prior art, the present invention has the following beneficial effects.

(1) The present invention discloses a method of directly adding a soluble porogen to a resin system, tiny pores that are uniform in pore size can be evenly distributed in resin matrix by means of a simple process at low cost, and a high-performance composition having a low dielectric constant and a low dielectric loss is obtained. Moreover, such method has good applicability to many resin systems. Since the pore size in the system reaches the nanometer level, this technical solution will not sacrifice the properties of the final system, such as mechanical strength, thermal properties, water absorption and the like.
(2) As a preferred technical solution, the use of the porogen that can decompose and release gas at a temperature of 100-190° C. can effectively control the period of pore formation and stabilize the pore size, so as to obtain pores with more uniform pore size and more even distribution

### EMBODIMENTS

The technical solution of the present invention is further explained by the following embodiments.

The following lists the product models used in the examples and comparison examples.

(1) DER530 from Dow Chemical, having an epoxy equivalent of 435;
(2) Dicyandiamide, a common epoxy curing agent in the industry;
(3) 2-methylimidazole and 2-phenylimidazole, common accelerators in the industry;
(4) 4-methylbenzenesulfonyl azide, which is an Aladdin reagent, in a liquid state, and soluble in common organic solvents, and has a decomposition temperature of 140° C.;
(5) N,N-dinitrosopentamethylene tetraamine, which is an Aladdin reagent, soluble in acetone, and has a decomposition temperature of 170-190° C. and an average particle size of 2-4 μm;
(6) Azodicarbonamide, which is an Aladdin reagent, insoluble in common organic solvents, and has a decomposition temperature of 160-195° C. and an average particle size of 2-4 μm;
(7) Ammonium bicarbonate, which is an Aladdin reagent, soluble in water and common organic solvents, and has a decomposition temperature 36-60° C.;
(8) PT-30, a phenol novolac cyanate ester from Longsha Group;
(9) Brominated styrene produced by Albemarle;
(10) MX9000 which is methyl methacrylate modified-polyphenylene ether from Sabic;
(11) Bifunctional maleimides produced by K-I chemical;
(12) R100, a styrene-butadiene copolymer from Samtomer;
(13) DCP which is dicumyl peroxide produced by Shanghai Gaoqiao;
(14) HP7200-H which is dicyclopentadiene epoxy from DIC;
(15) D125 which is benzoxazine resin produced by Sichuan Dongcai;
(16) EPONOL 6635M65 which is a linear novolac resin from Momentive, Korea.

### Experiment Group A (Table 1)

### EXAMPLES 1-3

100 parts by weight of epoxy resin DER530, 3 parts by weight of dicyandiamide, 0.05 parts by weight of 2-methylimidazole, 4-methylbenzenesulfonyl azide (having 1, 5, 10 parts by weight respectively) were dissolved in an organic solvent and mechanically stirred, formulated into 65 wt. % of a glue. Then glass fiber cloth was impregnated therewith, heated and dried to form a prepreg. Copper foils were placed on both sides of the prepreg, pressed and heated to produce a copper clad laminate.

### Comparison Examples 1-2

The embodiments are the same as Example 1, and their difference lies in that the porogen was in an amount of 0 part in Comparison Example 1, and 12 parts in Comparison Example 2.

### Experiment Group B (Table 2)

### Example 4

100 parts by weight of epoxy resin DER530, 3 parts by weight of dicyandiamide, 0.05 parts by weight of 2-methylimidazole and 5 parts by weight of N,N-dinitrosopentamethylene tetraamine were dissolved in an organic solvent and mechanically stirred, formulated into 65 wt. % of a glue. Then glass fiber cloth was impregnated therewith, heated and dried to form a prepreg. Copper foils were placed on both sides of the prepreg, pressed and heated to produce a copper clad laminate.

### Comparison Examples 3-4

The mass ratios and feeding modes of each component are the same as those in Example 4, and their difference lies in that the porogen was azodicarbonamide in Comparison Example 3, and ammonium bicarbonate in Comparison Example 4.

### Experiment Group C (Table 3)

### Example 5

100 parts by weight of epoxy resin DER530, 24 parts by weight of phenolic resin TD2090, 0.05 parts by weight of 2-methylimidazole and 5 parts by weight of a soluble porogen (4-methylbenzenesulfonyl azide) were dissolved in an organic solvent and mechanically stirred and emulsified, formulated into 65 wt. % of a glue. Then glass fiber cloth was impregnated therewith, heated and dried to form a prepreg. Copper foils were placed on both sides of the prepreg, pressed and heated to produce a copper clad laminate.

### Example 6

20 parts by weight of phenol novolac cyanate PT30, 40 parts by weight of o-cresol novolac epoxy resin N695, 20 parts by weight of brominated styrene and a proper amount of catalyst zinc octoate, 2-phenylimidazole, and 5 parts by weight of a soluble porogen (4-methylbenzenesulfonyl azide) were dissolved in an organic solvent and mechanically stirred and emulsified, formulated into 65 wt. % of a glue. Then glass fiber cloth was impregnated therewith, heated and dried to form a prepreg. Copper foils were placed on both sides of the prepreg, pressed and heated to produce a copper clad laminate.

### Example 7

70 parts by weight of vinyl-based thermosetting polyphenylene ether MX9000 dissolved in toluene, 5 parts by weight of bifunctional maleimide from KI Chemical dissolved in N,N-dimethylformamide, 25 parts by weight of butadiene-styrene copolymer R100, 3 parts by weight of a curing initiator DCP, and 5 parts by weight of a soluble porogen (4-methylbenzenesulfonyl azide) were dissolved in an organic solvent and mechanically stirred and emulsified, formulated into 65 wt. % of a glue. Then glass fiber cloth was impregnated therewith, heated and dried to form a prepreg. Copper foils were placed on both sides of the prepreg, pressed and heated to produce a copper clad laminate.

### Example 8

30 parts by weight of dicyclopentadiene epoxy HP-7200H, 60 parts by weight of benzoxazine resin D125, 5 parts by weight of linear novolac resin EPONOL 6635M65, 5 parts by weight of dicyandiamide, and 5 parts by weight of a soluble porogen (4-methylbenzenesulfonyl azide) were dissolved in an organic solvent and mechanically stirred and emulsified, formulated into 65 wt. % of a glue. Then glass fiber cloth was impregnated therewith, heated and dried to form a prepreg. Copper foils were placed on both sides of the prepreg, pressed and heated to produce a copper clad laminate.

### Comparison Examples 5-8

The embodiments therein correspond to those in Examples 5-8 respectively, and their difference lies in that the formulation systems in Comparison Examples 5-8 contain no soluble porogen.

TABLE 1
Effects of the amount of the porogen

| Formulation | | | | Comp. | |
|---|---|---|---|---|---|
| Types and | Examples | | | Examples | |
| amounts | No. | | | | |
| of the porogen | 1 | 2 | 3 | 1 | 2 |
| 4-methylbenzenesulfonyl azide | 1 | 5 | 10 | — | 12 |
| Material Properties | | | | | |
| Dielectric constant/dielectric | 4.5/0.011 | 4.2/0.008 | 4.1/0.008 | 4.7/0.011 | 4.1/0.075 |
| loss (1 MHz) | | | | | |
| Water absorption/% | 0.20 | 0.20 | 0.25 | 0.20 | 0.45 |
| Glass transition temperature | 135 | 135 | 134 | 135 | 128 |
| (Tg)/° C. | | | | | |
| Bending strength/MPa | 600/500 | 640/550 | 620/520 | 600/500 | 520/400 |
| (warp-wise/weft-wise) | | | | | |
| Bending modulus/GPa | 25/24 | 27/26 | 25/24 | 25/24 | 20/18 |
| (warp-wise/weft-wise) | | | | | |
| Tensile strength/MPa | 250/240 | 250/240 | 240/240 | 250/240 | 200/190 |
| (warp-wise/weft-wise) | | | | | |
| Peeling strength/N · mm⁻¹ | 1.60 | 1.62 | 1.59 | 1.60 | 1.47 |

TABLE 2
Effects of the type of the porogen

| | | | Comp. | |
|---|---|---|---|---|
| Formulation | Examples | | Examples | |
| Types and amounts | No. | | | |
| of the porogen | 2 | 4 | 3 | 4 |
| 4-methylbenzenesulfonyl azide | 5 | — | — | — |
| N,N-dinitrosopentamethylene | — | 5 | — | — |
| tetraamine | | | | |
| Azodicarbonamide | — | — | 5 | — |
| Ammonium bicarbonate | — | — | — | 5 |
| Material Properties | | | | |
| Dielectric constant/dielectric | 4.2/0.008 | 4.4/0.010 | 4.6/0.011 | 4.7/0.011 |
| loss (1 MHz) | | | | |
| Water absorption/% | 0.20 | 0.23 | 0.25 | 0.22 |
| Glass transition temperature | 135 | 131 | 122 | 130 |
| (Tg)/° C. | | | | |
| Bending strength/MPa | 640/550 | 590/510 | 550/460 | 590/500 |
| (warp-wise/weft-wise) | | | | |
| Bending modulus/GPa | 27/26 | 25/24 | 22/23 | 25/24 |
| (warp-wise/weft-wise) | | | | |
| Tensile strength/MPa | 250/240 | 230/230 | 180/180 | 250/240 |
| (warp-wise/weft-wise) | | | | |
| Peeling strength/N · mm⁻¹ | 1.60 | 1.59 | 1.42 | 1.60 |

TABLE 3
Effects of the type of the thermosetting resin system

| Formulation | Examples | | | | Comp. Examples | | | |
|---|---|---|---|---|---|---|---|---|
| Types and | No. | | | | | | | |
| amounts of the porogen | 5 | 6 | 7 | 8 | 5 | 6 | 7 | 8 |
| 4-methylbenzenesulfonyl | 5 | 5 | 5 | 5 | — | — | — | — |
| azide | | | | | | | | |
| Material Properties | | | | | | | | |
| Dielectric | 4.4/ | 4.1/ | 3.7/ | 3.9/ | 4.9/ | 4.4/ | 3.90/ | 4.2/ |
| constant/dielectric loss | 0.012 | 0.008 | 0.006 | 0.010 | 0.013 | 0.008 | 0.006 | 0.010 |
| (1 MHz) | | | | | | | | |
| Water absorption/% | 0.25 | 0.48 | 0.05 | 0.08 | 0.25 | 0.45 | 0.04 | 0.08 |
| Glass transition | 156 | 219 | 210 | 167 | 157 | 219 | 212 | 167 |
| temperature (Tg)/° C. | | | | | | | | |
| Bending strength/MPa | 550/ | 380/ | — | 550/ | 500/ | 330/ | — | 520/ |
| (warp-wise/weft-wise) | 500 | 350 | | 550 | 450 | 330 | | 530 |
| Bending modulus/GPa | 24/ | 19/ | — | — | 22/ | 16/ | — | — |
| (warp-wise/weft-wise) | 24 | 17 | | | 21 | 17 | | |
| Tensile strength/MPa | 260/ | 200/ | — | — | 260/ | 210/ | — | — |
| (warp-wise/weft-wise) | 260 | 190 | | | 260 | 210 | | |
| Peeling strength/N · mm⁻¹ | 1.55 | 1.00 | 1.40 | 1.41 | 1.55 | 1.02 | 1.45 | 1.43 |

Those skilled in the art shall know that the above examples are merely used for understanding the present invention, rather than specific limitations to the present invention.

According to the performance test results in Table 1, it can be seen that, since homogeneously-distributed micropores and nanopores are formed inside the system in the examples in which the soluble porogen is added, the dielectric constant thereof is reduced apparently. Moreover, the formed micropores can prevent the cracks from expanding when the sheets are pressed, thereby resulting in a certain increase in the bending strength, bending modulus and the like. However, the tensile strength, peeling strength and glass transition temperature are not affected basically. When the soluble porogen is added in an amount of 5 wt. %, such system has a lower dielectric constant and loss, as well as best bending strength. Along with further increase of the amount of the porogen (Comparison Example 2), the decrease of the dielectric loss of the sheet is not obvious. However, the glass transition temperature and mechanical performance are reduced greatly. Meanwhile, the bubbles produced during the decomposition thereof greatly reduce the peeling strength of the sheets. Thus the amount of the porogen is preferably 1-10 wt. %.

According to the performance test results in Table 2, it can be seen that Example 2 has the best overall performance. This is mainly due to the fact that the decomposition temperature of 4-methylbenzenesulfonyl azide is in the production temperature range of common copper clad laminates, and it is liquid at room temperature and can form a homogeneous system with epoxy resin; and the porogen can be dispersed into the entire formulation system in a molecular grade. The pore size reaches the nanometer level and has entire plate uniformity.

The porogen used in Example 5 is N,N-dinitrosopentamethylene tetraamine, which has a decomposition temperature higher than 170° C. and can be dissolved in a solvent such as acetone at room temperature, and can also be well dispersed throughout the entire epoxy formulation system, and has better pore-forming effect. The porogen used in Comparison Example 3 is azodicarbonamide, which has a decomposition temperature higher than 160° C., but is insoluble in common organic solvents, so that it cannot be well dispersed in the entire formulation system. By the experimental investigation, it can be found that it has an uneven pore-forming distribution, a pore size of more than 20 microns, as well as greatly reduced glass transition temperature, peeling strength and mechanical strength of the sheets, so that it cannot meet the reliability of copper clad laminates and PCB processing requirements. The porogen used in Comparison Example 4 is ammonium bicarbonate having a decomposition temperature of about 40° C. During the sizing process, the porogen is completely decomposed, thereby being unable to reduce the dielectric constant.

On the other hand, it can be seen from the performance test results in Table 3 that soluble high-temperature porogens in different thermosetting resin systems (Example 5 and Comparison Example 5 are phenolic aldehyde-cured epoxy systems; Example 6 and Comparison Example 6 are cyanate ester-epoxy systems; Example 7 and Comparison Example 7 are polyphenylene ether systems; Example 8 and Comparison Example 8 are epoxy-benzoxazine systems) can reduce the dielectric constant, without reducing the glass transition temperature, peeling strength or tensile strength, and can increase the bending strength of the sheets to a certain degree.

The applicant claims that the present invention describes the detailed process of the present invention, but the present invention is not limited to the detailed process of the present invention. That is to say, it does not mean that the present invention shall be carried out with respect to the above-described detailed process of the present invention. Those skilled in the art shall know that any improvements to the present invention, equivalent replacements of the raw materials of the present invention, additions of auxiliary, selections of any specific ways all fall within the protection scope and disclosure scope of the present invention.

1-12. (canceled)

13. A thermosetting resin composition, comprising a thermosetting resin, a crosslinking agent, an accelerator and a porogen, wherein the porogen is soluble in an organic solvent.

14. The composition claimed in claim 13, wherein the organic solvent is any one selected from the group consisting of N,N-dimethylformamide, N,N-dimethylacetamide, dimethyl sulfoxide, N-methyl-2-pyrrolidone, propylene glycol methyl ether, propylene glycol methyl ether acetate, ethyl acetate, dichloromethane, cyclohexanone, butanone, acetone, ethanol, toluene, xylene, and a mixture of at least two selected therefrom.

15. The composition claimed in claim 13, wherein the porogen is any one selected from the group consisting of azo compound, nitroso compound, dicarbonate compound, azide compound, hydrazine compound, and a combination of at least two selected therefrom.

16. The composition claimed in claim 15, wherein the nitroso compound is in a powder shape having an average particle size of 0.1-50 μm.

17. The composition claimed in claim 13, wherein the porogen is present in an amount of 10 wt. % or less in the thermosetting resin composition.

18. The composition claimed in claim 13, wherein the porogen can release gas at 100-190° C.

19. The composition claimed in claim 13, wherein the porogen is nitroso compound and/or azide compound.

20. The composition claimed in claim 13, wherein the porogen is sulfonyl azide compound.

21. The composition claimed in claim 13, wherein the composition comprises the following components, in percent by weight,
from 50 to 90 wt. % of a thermosetting resin, less than 30 wt. % of a crosslinking agent, from 0.1 to 10 wt. % of an accelerator and less than 10 wt. % of a porogen, wherein the sum of the weight percents of all components in the composition is 100 wt. %.

22. The composition claimed in claim 13, wherein the composition comprises the following components, in percent by weight,
from 50 to 70 wt. % of a thermosetting resin, from 10 to 30 wt. % of a crosslinking agent, from 3 to 10 wt. % of an accelerator and from 3 to 10 wt. % of a porogen, wherein the sum of the weight percents of all components in the composition is 100 wt. %.

23. The composition claimed in claim 13, wherein the thermosetting resin is any one selected from the group consisting of polymers crosslinkable to form a network structure, or a combination of at least two selected therefrom.

24. The composition claimed in claim 13, wherein the thermosetting resin is any one selected from the group consisting of epoxy resin, phenolic resin, cyanate resin, polyamide resin, polyimide resin, polyether resin, polyester resin, hydrocarbon resin, benzoxazine resin, silicone resins, and a combination of at least two selected therefrom.

25. A resin glue, wherein the resin glue is obtained by dispersing the thermosetting resin composition in claim 13 in a solvent.

26. The resin glue claimed in claim 25, wherein the solvent is any one selected from the group consisting of N,N-dimethylformamide, N,N-dimethylacetamide, dimethyl sulfoxide, N-methyl-2-pyrrolidone, propylene glycol methyl ether, propylene glycol methyl ether acetate, ethyl acetate, dichloromethane, cyclohexanone, butanone, acetone, ethanol, toluene, xylene, and a combination of at least two selected therefrom.

27. A prepreg, wherein the prepreg comprises a reinforcing material and the thermosetting resin composition according to claim 13 attached thereon after impregnating and drying.

28. A laminate comprising at least one prepreg of claim 27.

29. A printed circuit board comprising at least one laminate of claim 28.
